(19) United States
(12) Patent Application Publication
(10) Pub. No.: US 2026/0014767 A1
(43) Pub. Date: Jan. 15, 2026

(54) MANUFACTURING APPARATUS FOR ELECTRODE AND MANUFACTURING METHOD THEREOF

(71) Applicant: SK On Co., Ltd., Seoul (KR)

(72) Inventor: Sang Heon SONG, Daejeon (KR)

(21) Appl. No.: 19/263,497

(22) Filed: Jul. 9, 2025

(30) Foreign Application Priority Data
Jul. 12, 2024 (KR) 10-2024-0092125

(51) Int. Cl. B30B 5/06; H01M 4/04

(52) U.S. Cl. CPC B30B 5/06; H01M 4/0404; H01M 4/0435; H01M 4/0471

(57) ABSTRACT

The present disclosure provides a manufacturing apparatus for an electrode including a coated portion on which an active material is applied to a foil and a non-coated portion on which an active material is not applied to the foil, the manufacturing apparatus including: an elongating belt portion configured to elongate the non-coated portion by pressurizing the non-coated portion; and a rolling roller portion configured to roll the coated portion by pressurizing the coated portion, and the elongating belt portion includes an upper elongating portion including an upper belt pressurizing the non-coated portion in an upper portion of the non-coated portion, and a lower elongating portion including a lower belt pressurizing the non-coated portion in a lower portion of the non-coated portion.

### CROSS-REFERENCE TO RELATED APPLICATION(S)

This patent document claims the priority and benefits of Korean Patent Application No. 10-2024-0092125 filed on Jul. 12, 2024, the disclosure of which is incorporated herein by reference in its entirety.

### TECHNICAL FIELD

The disclosure and implementations disclosed in this patent document generally relate to a manufacturing apparatus for an electrode including a coated portion and a non-coated portion, and a manufacturing method thereof, and more particularly, to a manufacturing apparatus for an electrode by rolling a coating electrode to which a coated portion is applied, and a manufacturing method thereof.

### BACKGROUND

A secondary battery cell is an energy storage means that may be charged with and discharged of electricity. A secondary battery cell is widely used in various means that use electricity as a power source. For example, the secondary battery cell is used in various fields ranging from small devices such as mobile phones, laptop computers, and tablets, to vehicles and energy storage devices.

A secondary battery cell may include a case (e.g., a can, a pouch, or the like) and an electrode assembly. The electrode assembly includes an electrode and a separator and may be accommodated inside the case.

The electrode may include a coated portion in which an active material is applied to a foil and a non-coated portion in which an active material is not applied to the foil. The coating electrode (electrode substrate) in which an active material is applied to a portion of the foil may undergo a rolling process (or a pressurizing process) to improve the energy density per unit volume.

### SUMMARY

Through the rolling process, the density of an electrode composite layer of a coating electrode (electrode substrate) may increase and a volume thereof may decrease. In the process of rolling the electrode under high pressure, the electrode may be fractured due to the difference in the amount of elongation between a coated portion and a non-coated portion. For example, due to the difference in the thickness of the coated portion and the non-coated portion, a difference in the amount of pressure applied by a rolling roller may occur between the coated portion and the non-coated portion, and thus a difference in the amount of elongation may occur.

According to an aspect of the present disclosures, a manufacturing apparatus for an electrode capable of preventing or reducing fracturing of the electrode and a manufacturing method of the electrode may be provided.

According to an aspect of the present disclosures, a manufacturing apparatus for an electrode capable of reducing stress applied to the non-coated portion during an elongation process of a non-coated portion and a manufacturing method of the electrode may be provided.

According to another aspect of the present disclosures, a manufacturing apparatus for an electrode capable of reducing a fracture of the electrode while minimizing a decrease in the strength of the electrode and a manufacturing method of the electrode may be provided.

A battery cell including an electrode manufactured by a manufacturing apparatus for the electrode and/or a manufacturing method of the electrode of the present disclosure may be widely applied to electric vehicles, battery charging stations, and devices within green technology fields such as solar power generation and wind power generation using other batteries. Additionally, the battery cell including the electrode manufactured by the manufacturing apparatus for the electrode and/or the manufacturing method of the electrode of the present disclosure may be used in eco-friendly electric vehicles, hybrid vehicles, and the like, for ameliorating the effects of climate change by suppressing air pollution and greenhouse gas emissions.

A manufacturing apparatus for an electrode of the present disclosure including a coated portion on which an active material is applied to a foil and a non-coated portion on which an active material is not applied to the foil, may include an elongating belt portion configured to elongate the non-coated portion by pressurizing the non-coated portion; and a rolling roller portion configured to roll the coated portion by pressurizing the coated portion, and the elongating belt portion may include an upper elongating portion including an upper belt pressurizing the non-coated portion in an upper portion of the non-coated portion, and a lower elongating portion including a lower belt pressurizing the non-coated portion in a lower portion of the non-coated portion.

In an embodiment, on an inner surface of the upper belt, a length of the upper belt in a direction of movement of the electrode may be greater than a height of the upper belt, and on an inner surface of the lower belt, a length of the lower belt in the direction of movement of the electrode may be greater than a height of the lower belt.

In an embodiment, the length of the upper belt may be two or more times the height of the upper belt, and the length of the lower belt may be two or more times the height of the lower belt.

In an embodiment, at least one of the upper belt or the lower belt may include a pattern having a concave-convex shape formed on an outer surface.

In an embodiment, the pattern may include a concave portion and a convex portion, and the convex portion may include a curved shape.

In an embodiment, the pattern may have a constant pitch and height.

In an embodiment, the upper elongating portion may further include an upper roller including a plurality of rollers disposed on an inner side of the upper belt, and the lower elongating portion may further include a lower roller including a plurality of rollers disposed on an inner side of the lower belt.

In an embodiment, the upper roller may be in contact with both upper and lower sides of an inner surface of the upper belt, respectively, and the lower roller may be in contact with both upper and lower sides of an inner surface of the lower belt, respectively.

In an embodiment, at least one of the plurality of rollers disposed on the upper roller may provide driving force to the upper belt, and at least one of the plurality of rollers disposed on the lower roller may provide driving force to the lower belt.

In an embodiment, at least some rollers, among the plurality of rollers provided to the upper roller and the lower roller may include a surface treatment portion configured to increase a coefficient of friction when in contact with an inner surface of the upper belt or an inner surface of the lower belt, as compared to a roller surface that is not surface-treated or which is smooth.

In an embodiment, the surface treatment portion may include at least one of a concave-convex portion formed to have a predetermined pattern on a surface of the at least some rollers or formed by concave-convex processing, or a surface coated portion in which a coating material is coated on a surface of the at least some rollers.

In an embodiment, the upper elongating portion may further include an upper auxiliary roller including at least one auxiliary roller disposed between the at least some rollers, among the plurality of rollers provided to the upper roller.

In an embodiment, the upper auxiliary roller is in contact with an inner surface of the upper belt below a central axis of the upper roller.

In an embodiment, the lower elongating portion may further include a lower auxiliary roller including at least one auxiliary roller disposed between at least some rollers, among the plurality of rollers provided to the lower roller.

In an embodiment, the lower auxiliary roller may be in contact with the inner surface of the lower belt above a central axis of the lower roller.

In an embodiment, at least one of the plurality of rollers disposed on the upper roller or the plurality of rollers disposed on the lower roller may include a heater.

In an embodiment, the rolling roller portion may be disposed at a rear end of the elongating belt portion in a direction of movement of the electrode.

A manufacturing apparatus for an electrode according to another embodiment may further include: a heating portion disposed in a front end of the elongating belt portion in a direction of movement of the electrode to heat the non-coated portion.

A manufacturing method of an electrode according to the present disclosure may include: a process of preparing a coating electrode including a coated portion in which an active material is applied to a foil and a non-coated portion in which the active material is not applied to the foil; a process of elongating the non-coated portion by pressurizing the non-coated portion; and a process of rolling the coated portion by pressurizing the coated portion, and in the process of elongating the non-coated portion, pressure may be applied to the non-coated portion using an upper elongating portion including an upper belt pressurizing the non-coated portion in an upper portion of the non-coated portion, and a lower elongating portion including a lower belt pressurizing the non-coated portion in a lower portion of the non-coated portion.

In an embodiment, at least one of the upper belt or the lower belt may include a pattern having a concave-convex shape formed on an outer surface the at least one of the upper belt or the lower belt, and in the process of elongating the non-coated portion, a concave-convex shape corresponding to the pattern may be formed in the non-coated portion.

In an embodiment, the upper elongating portion may further include an upper roller disposed on an inner side of the upper belt and provided with a plurality of rollers, the lower elongating portion may further include a lower roller disposed on an inner side of the lower belt and provided with a plurality of rollers, and in the process of elongating the non-coated portion, the upper roller may support an inner surface of the upper belt and the lower roller supports an inner surface of the lower belt.

In an embodiment, the upper elongating portion may further include an upper auxiliary roller disposed between at least some rollers, among the plurality of rollers provided to the upper roller, the lower elongating portion may further include a lower auxiliary roller disposed between at least some rollers, among the plurality of rollers provided to the lower roller, and in the process of elongating the non-coated portion, the upper auxiliary roller may support the inner surface of the upper belt together with the upper roller, and the lower auxiliary roller may support the inner surface of the lower belt together with the lower roller.

The manufacturing method of an electrode in an embodiment may further include: a heating process of heating the non-coated portion, and the heating process may be performed before the process of elongating the non-coated portion, and the process of rolling the coated portion may be performed subsequent to the process of elongating the non-coated portion.

According to an embodiment of the present disclosure, it may be possible to prevent or reduce a fracture phenomenon of an electrode.

According to an embodiment of the present disclosure, it may be possible to reduce the stress applied to a non-coated portion during an elongation process of the non-coated portion.

According to an embodiment of the present disclosure, it may be possible to reduce a fracture phenomenon of an electrode while minimizing a decrease in strength of an electrode.

### BRIEF DESCRIPTION OF DRAWINGS

Certain aspects, features, and advantages of the present disclosure are illustrated by the following detailed description with reference to the accompanying drawings.

FIG. 1 is a perspective view schematically illustrating a manufacturing apparatus for an electrode according to an embodiment.

FIG. 2 is a plan view of the manufacturing apparatus for an electrode illustrated in FIG. 1.

FIG. 3 is a perspective view of an elongating belt portion illustrated in FIG. 1.

FIG. 4 is a cross-sectional view illustrating the elongating belt portion illustrated in FIG. 3 along line I-I′ of FIG. 2.

FIG. 5 is a schematic cross-sectional view illustrating a non-coated portion modified by the elongating belt portion illustrated in FIG. 4.

FIG. 6 is a cross-sectional view illustrating a modified example of the elongating belt portion illustrated in FIG. 4.

FIG. 7 is a cross-sectional view illustrating another modified example of the elongating belt portion illustrated in FIG. 4.

FIG. 8A and FIG. 8B are cross-sectional views illustrating circumferential cross-sections of rollers, respectively.

FIG. 9 is a plan view illustrating a manufacturing apparatus for an electrode according to a modified embodiment.

FIG. 10 is a perspective view schematically illustrating a manufacturing apparatus for an electrode according to another embodiment.

FIG. 11 is a flow chart illustrating a manufacturing method of an electrode according to an embodiment.

### DETAILED DESCRIPTION

Hereinafter, the present disclosure will be described in detail with reference to the attached drawings. However, this is merely exemplary and the present disclosure is not limited to the specific embodiments described as exemplary.

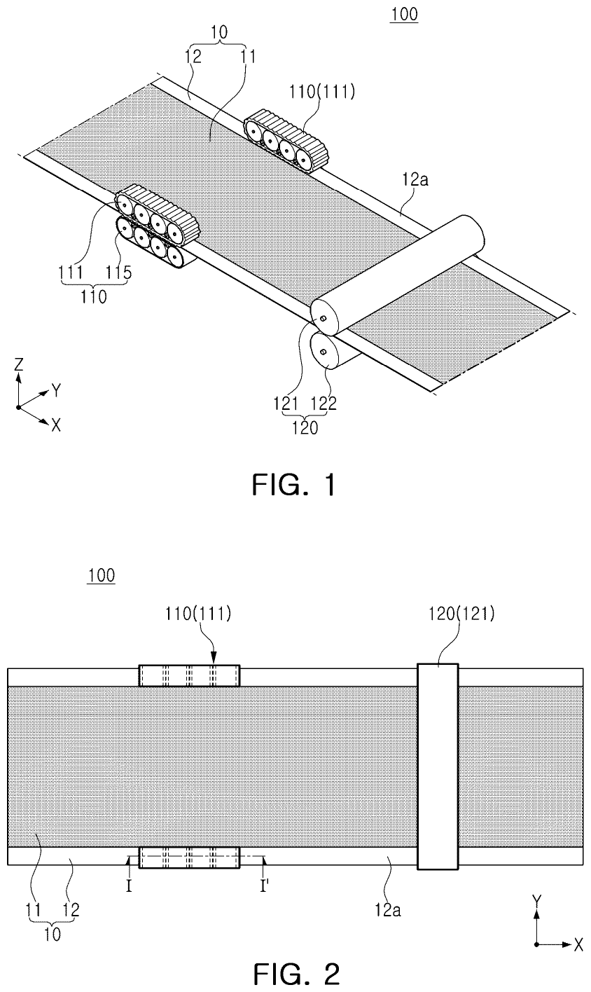

Referring to FIGS. 1 to 5, a manufacturing apparatus 100 for an electrode according to an embodiment will be described.

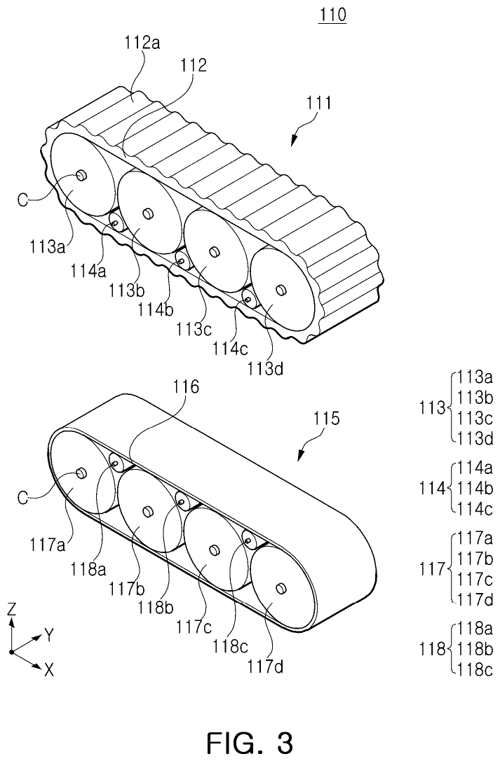

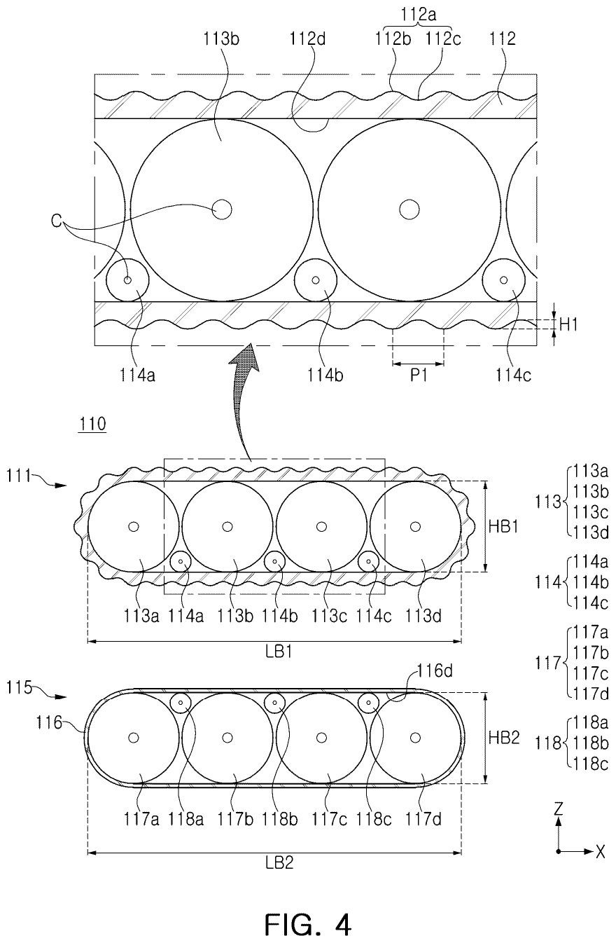

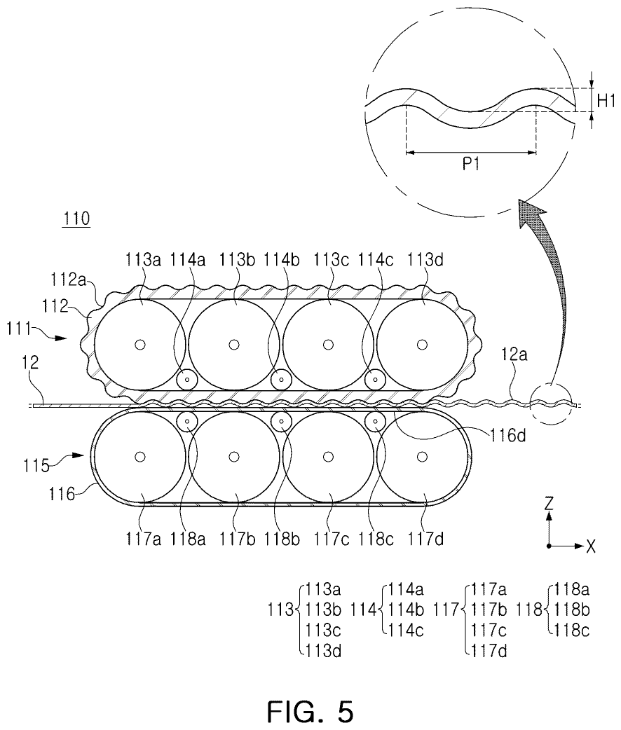

FIG. 1 is a perspective view schematically illustrating a manufacturing apparatus 100 for an electrode according to an embodiment, FIG. 2 is a plan view of the manufacturing apparatus 100 for an electrode illustrated in FIG. 1, FIG. 3 is a perspective view of an elongating belt portion 110 illustrated in FIG. 1, FIG. 4 is a cross-sectional view illustrating the elongating belt portion 110 illustrated in FIG. 3 along line I-I′ of FIG. 2, and FIG. 5 is a schematic cross-sectional view illustrating a non-coated portion 12 modified by the elongating belt portion 110 illustrated in FIG. 4.

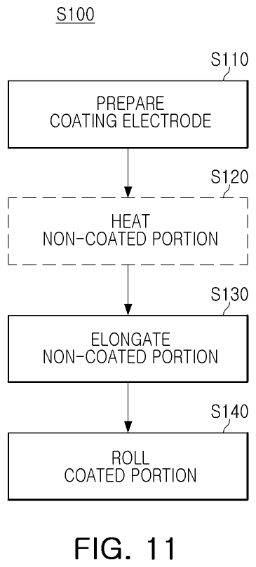

An electrode 10 may include a cathode electrode and an anode electrode. The electrode 10 may be formed by applying a slurry to a foil (or current collector) made of aluminum or copper. The slurry includes an active material, a conductive agent, and a binder, and may be applied to both surfaces of the foil. The electrode 10 may include a coated portion 11 to which the slurry is applied, and a non-coated portion 12 to which the slurry is not applied. The coated portion is also known as an applied portion, and the non-coated portion 12 is also known as a non-applied portion. The manufacturing apparatus 100 for an electrode and a manufacturing method (S100 of FIG. 11) of an electrode of the present disclosure may be applied to the manufacturing of a cathode electrode and an anode electrode.

Referring to FIGS. 1 to 5, the manufacturing apparatus 100 for an electrode according to an embodiment is a manufacturing apparatus for an electrode including a coated portion in which an active material is applied to a foil and a non-coated portion in which the active material is not applied to the foil. A manufacturing apparatus 100 for an electrode according to an embodiment may include an elongating belt portion 110 configured to elongate the non-coated portion 12 by pressurizing the non-coated portion 12, and a rolling roller portion configured to roll the coated portion by pressurizing the coated portion. The elongating belt portion 110 may include an upper elongating portion 111 including an upper belt 112 pressurizing the non-coated portion 12 in an upper portion of the non-coated portion 12, and a lower elongating portion 115 including a lower belt 116 pressurizing the non-coated portion 12 in a lower portion of the non-coated portion 12.

The elongating belt portion 110 may elongate the non-coated portion 12 by pressurizing the non-coated portion 12. The elongating belt portion 110 may be disposed in an upper portion and a lower portion of the electrode 10, respectively, and may pressurize the non-coated portion 12 in the upper portion and the lower portion of the non-coated portion 12.

The elongating belt portion 110 may include an upper belt 112 disposed on the upper portion of the non-coated portion 12 and a lower belt 116 disposed on the lower portion of the non-coated portion 12. The upper belt 112 may pressurize the non-coated portion 12 in the upper portion of the non-coated portion 12. The lower belt 116 may pressurize the non-coated portion 12 in the lower portion of the non-coated portion 12. Accordingly, the non-coated portion 12 may be pressurized and elongated between the upper belt 112 and the lower belt 116.

The upper belt 112 and the lower belt 116 of the elongating belt portion 110 may cover the non-coated portion 12 in a width direction (Y-direction) of the electrode 10. A plurality of rollers provided in the elongating belt portion 110 may be disposed in a position that does not cover the coated portion 11. However, the elongating belt portion 110 may also have a size of pressurizing a portion of the coated portion 11 together with the non-coated portion 12.

The elongating belt portion 110 may have a shape in which a length of the electrode in a movement direction (X-direction) is greater than a height thereof. On an inner surface 112d of the upper belt 112, a length LB1 of the upper belt 112 in the movement direction (X-direction) of the electrode may be greater than a height HB1 of the upper belt 112. On an inner surface 116d of the lower belt 116, a length LB2 of the lower belt 116 in the movement direction (X-direction) of the electrode may be greater than a height HB2 of the lower belt 116.

According to an embodiment, since the length LB1 of the upper belt 112 is greater than the height HB1 and the length LB2 of the lower belt 116 is greater than the height HB2, the time of the process of performing the elongation may be lengthened.

Specifically, when the elongation is performed in a short section in a state in which the moving speed of the electrode 10 is high, a large amount of deformation should be applied to the non-coated portion 12 instantaneously. On the other hand, according to an embodiment, since the elongation is performed through the elongating belt portion 110 having a long length in the movement direction (X-direction) of the electrode, the time of the process of performing the elongation of the non-coated portion 12 may increase, so that the amount of strain applied to the non-coated portion 12 may be distributed by the upper belt 112 and/or lower belt 116 having a long length. Accordingly, according to an embodiment, a fracture phenomenon occurring in the boundary area of the non-coated portion 12 or the non-coated portion 12 and the coated portion 11 during the elongation of the non-coated portion 12 may be reduced.

The length LB1 of the upper belt 112 may have the same value as the length LB2 of the lower belt 116, but one length may also be formed longer.

The length LB1 of the upper belt 112 may be two or more times the height HB1 of the upper belt 112, and the length LB2 of the lower belt 116 may be two or more times the height HB2 of the lower belt 116. When the length LB1 of the upper belt 112 is less than twice the height HB1 of the upper belt 112 and the length LB2 of the lower belt 116 is less than twice the height HB2 of the lower belt 116, since a length of a section in which the elongation is performed is shortened, the time of the process in which the elongation of the non-coated portion 12 is performed is reduced, and a fracture phenomenon may occur in the non-coated portion 12 or a boundary region between the non-coated portion 12 and the coated portion 11.

The length LB1 of the upper belt 112 may be less than 10, 7, or 5 times the height HB1 of the upper belt 112, and the length LB2 of the lower belt 116 may be less than 10, 7, or 5 times the height HB2 of the lower belt 116. When the length LB1 of the upper belt 112 and/or the length LB2 of the lower belt 116 becomes longer than necessary, a space occupied by the elongating belt portion 110 may increase, and the equipment costs may also increase. However, when there is no restriction on an installation space of the elongating belt portion 110, the length LB1 of the upper belt 112 and/or the length LB2 of the lower belt 116 may have a value of 10 times or more the height.

The length LB1 of the upper belt 112 and/or the length LB2 of the lower belt 116 may have a value greater than a width of the non-coated portion 12. The length LB1 of the upper belt 112 and/or the length LB2 of the lower belt 116 may have a value greater than or equal to twice the width of the non-coated portion 12. In this case, since a section for elongating the non-coated portion 12 becomes longer and the elongation process time increases, the fracture phenomenon occurring in the non-coated portion 12 or a boundary region between the non-coated portion 12 and the coated portion 11 during the elongation process of the non-coated portion 12 may be reduced.

In order to prevent damage to the non-coated portion 12 during the pressurization process of the non-coated portion 12, a material of the upper belt 112 and the lower belt 116 may include a material capable of elastic deformation. For example, the material of the upper belt 112 and the lower belt 116 may include natural rubber or synthetic rubber. However, the material of the upper belt 112 and the lower belt 116 is not limited thereto, and may include various types of synthetic resins such as Polyvinyl Chloride (PVC), Polyethylene (PE), and Thermoplastic polyurethane (TPU).

At least one of the upper belt 112 or the lower belt 116 may include a pattern 112a in a protruding shape formed on an outer surface thereof.

In an embodiment illustrated in FIGS. 1 to 5, a pattern 112a having a protruding shape may be formed on an outer surface of one of the upper belt 112 and the lower belt 116, and the outer surface of the other may have a flat shape. Since the upper belt 112 and/or the lower belt 116 include a material that may be elastically modified, even if the pattern 112a is formed on only one of the upper belt 112 and the lower belt 116, the pattern 112a of the belt may be easily transferred to the non-coated portion 12.

For example, the upper belt 112 may include the pattern 112a having a protruding shape, formed on the outer surface, and the lower belt 116 may have a flat shape on an outer surface thereof. When the pattern 112a having a protruding shape is formed on the outer surface of the upper belt 112, the shape of the non-coated portion 12 processed by the pattern 112a of the upper belt 112 may be easily confirmed. In contrast, the outer surface of the upper belt 112 may also have a flat shape, and the pattern 112a may also be formed on the outer surface of the lower belt 116.

The pattern 112a may include a concave portion 112c and a convex portion 112b. The concave portion 112c and the convex portion 112b may have a shape extending along a width direction of the belt (corresponding to a width direction of the electrode). The non-coated portion 12 may be modified into a shape similar to the pattern 112a by the pattern 112a having the concave portion 112c and the convex portion 112b. For example, as shown in FIG. 5, a cross-section of a non-coated portion 12a in an elongated state may have a wave-like shape.

The convex portion 112b may include a curved shape. The convex portion 112b may have a peak portion formed into a curved surface. The curved convex portion 112b may be modified by gently pressurizing the non-coated portion 12.

In an embodiment, the pattern 112a may have a constant pitch P1 and a constant height Hi. In this case, a cross-section of the non-coated portion 12a in the elongated state may have a shape similar to a sine curve or a cosine curve.

The amount of deformation by which the non-coated portion 12 is elongated by the elongating belt portion 110 or a maximum depth by which the non-coated portion 12 is pressurized may be adjusted according to the amount of deformation by which the coated portion 11 is elongated when the coated portion 11 is pressurized by a rolling roller portion 120. The amount of deformation by which the non-coated portion 12 is elongated by the elongating belt portion 110 may be set to have a value identical to or similar to an amount of deformation by which the coated portion 11 is elongated by the rolling roller portion 120. The amount of deformation by which the non-coated portion 12 is elongated may be adjusted by the height Hi of the pattern 112a. The maximum depth by which the non-coated portion 12 is pressurized may have a value of more than 0 mm, 0.5 mm or more, 1 mm or more, 2 mm or more, 3 mm or more, or 5 mm or more. A maximum depth by which the non-coated portion 12 is pressurized may have a value of 100 mm or less, 50 mm or less, 30 mm or less, 20 mm or less, or 10 mm or less. A maximum depth by which the non-coated portion 12 is pressurized may be set within the limit by which the non-coated portion 12 may be elongated without being fractured.

When manufacturing an electrode 10 in which the non-coated portion 12 is disposed on both sides of the coated portion 11 in the width direction (Y-direction), the elongating belt portion 110 may be disposed in each non-coated portion 12. The plurality of rollers disposed in each non-coated portion 12 may face each other, and central axes C of the rollers facing each other may form a straight line.

The upper elongating portion 111 may further include an upper roller 113. That is, in an embodiment, the upper elongating portion 111 may include an upper belt 112 and an upper roller 113. The upper roller 113 may include a plurality of rollers disposed on an inner side of the upper belt 112. The upper roller 113 may support the inner surface 112d of the upper belt 112 on the inner side of the upper belt 112. The upper roller 113 may function to limit the deformation of the upper belt 112 in an inward direction when the upper belt 112 pressurizes the non-coated portion 12, so that pressurizing force of the upper belt 112 may be transmitted to the non-coated portion 12.

The upper roller 113 may be in contact both an upper side and a lower side of the inner surface 112d of the upper belt 112, respectively. The upper roller 113 may support the inner surface 112d on an upper side and the inner surface 112d on a lower side of the upper belt 112 on the inner side of the upper belt 112.

The upper roller 113 may include two or more rollers. For example, the upper roller 113 may include a first upper roller 113a, a second upper roller 113b, a third upper roller 113c, and a fourth upper roller 113d. However, the number of rollers provided to the upper roller 113 is not limited thereto, and if the number of rollers is two or more, various changes thereof are possible. If the number of rollers provided to the upper roller 113 is two or more, as described above, the length LB1 of the upper belt 112 on the inner surface 112d of the upper belt 112 may have a value that is two or more times the height HB1 of the upper belt 112.

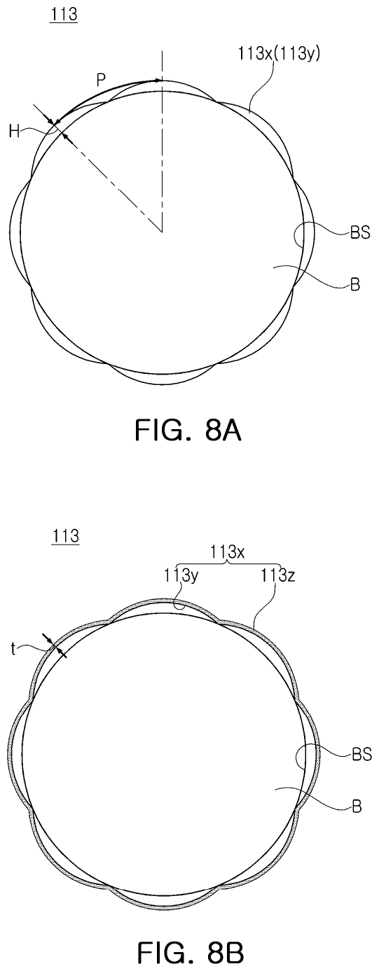

At least one of the plurality of rollers disposed in the upper roller 113 may provide driving force to the upper belt 112. For example, the first upper roller 113a may function as a driving roller that is connected to a driving means such as a motor and rotates, and may rotate the upper belt 112. Since the first upper roller 113a may have a long length of an area in contact with the upper belt 112, the first upper roller 113a may smoothly transmit the driving force to the upper belt 112. A surface treatment portion 113x (see FIG. 8A) may be formed on an outer surface of the first upper roller 113a so that the driving force of the first upper roller 113a may be transmitted to the upper belt 112. The surface treatment portion 113x (see FIG. 8A) may prevent slipping between the first upper roller 113a and the inner surface 112d of the upper belt 112. Alternatively, the number of rollers transmitting the driving force to the upper belt 112 may be two or more. A position and the number of rollers providing the driving force to the upper belt 112 may be variously changed.

The lower elongating portion 115 may further include a lower roller 117. That is, in an embodiment, the lower elongating portion 115 may include a lower belt 116 and a lower roller 117. The lower roller 117 may include a plurality of rollers disposed on an inner side of the lower belt 116. The lower roller 117 may support an inner surface 116d of the lower belt 116 on the inner side of the lower belt 116. The lower roller 117 may function to limit the deformation of the lower belt 116 in the inward direction when the lower belt 116 pressurizes the non-coated portion 12, so that pressurizing force of the lower belt 116 may be transmitted to the non-coated portion 12.

The lower roller 117 may contact both an upper side and a lower side of the inner surface 116d of the lower belt 116, respectively. The lower roller 117 may support the inner surface on an upper side and the inner surface on a lower side of the lower belt 116 on the inner side of the lower belt 116.

The lower roller 117 may include two or more rollers. For example, the lower roller 117 may include a first lower roller 117a, a second lower roller 117b, a third lower roller 117c, and a fourth lower roller 117d. However, the number of rollers provided to the lower roller 117 is not limited thereto, and if the number of rollers is two or more various changes thereof are possible. When the number of rollers provided to the lower roller 117 is two or more, as described above, the length LB2 of the lower belt 116 on the inner surface 116d of the lower belt 116 may have a value that is two or more times the height HB2 of the lower roller 117.

At least one of the plurality of rollers disposed in the lower roller 117 may provide driving force to the lower belt 116. For example, the first lower roller 117a may function as a driving roller that is connected to a driving means such as a motor, and may rotate the lower belt 116. Since the first lower roller 117a has a long length of an area in contact with the lower belt 116, the first lower roller 117a may smoothly transmit the driving force to the upper belt 112. A surface treatment portion 113x (see FIG. 8A) may be formed on an outer surface of the first lower roller 117a so that the driving force of the first lower roller 117a may be transmitted to the upper belt 112. The surface treatment portion 113x (see FIG. 8A) may prevent slipping between the first lower roller 117a and the inner surface 116d of the lower belt 116. Alternatively, the number of rollers transmitting the driving force to the lower belt 116 may be two or more. A position and the number of rollers providing the driving force to the lower belt 116 may be variously changed.

The upper elongating portion 111 may further include an upper auxiliary roller 114. That is, in an embodiment, the upper elongating portion 111 may include an upper belt 112, an upper roller 113, and an upper auxiliary roller 114. The upper auxiliary roller 114 may include at least one auxiliary roller disposed between at least some rollers, among the plurality of rollers provided to the upper roller 113.

For example, the upper auxiliary roller 114 may include a first upper auxiliary roller 114a disposed between the first upper roller 113a and the second upper roller 113b, a second upper auxiliary roller 114b disposed between the second upper roller 113b and the third upper roller 113c, and a third upper auxiliary roller 114c disposed between the third upper roller 113c and the fourth upper roller 113d.

The upper auxiliary roller 114 may be in contact with the inner surface 112d of the upper belt 112 below a central axis C of the upper roller 113. When the upper belt 112 pressurizes the non-coated portion 12, the upper auxiliary roller 114 may function to limit the deformation of the upper belt 112 in the inward direction between the plurality of rollers provided to the upper roller 113, so that the pressurizing force of the upper belt 112 may be transmitted to the non-coated portion 12.

The lower elongating portion 115 may further include a lower auxiliary roller 118. That is, in an embodiment, the lower elongating portion 115 may include a lower belt 116, a lower roller 117, and a lower auxiliary roller 118. The lower auxiliary roller 118 may include at least one auxiliary roller disposed between at least some rollers, among the plurality of rollers provided to the lower roller 117.

For example, the lower auxiliary roller 118 may include a first lower auxiliary roller 118a disposed between the first lower roller 117a and the second lower roller 117b, a second lower auxiliary roller 118b disposed between the second lower roller 117b and the third lower roller 117c, and a third lower auxiliary roller 118c disposed between the third lower roller 117c and the fourth lower roller 117d.

The lower auxiliary roller 118 may be in contact with the inner surface 116d of the lower belt 116 above the central axis C of the lower roller 117. When the lower belt 116 pressurizes the non-coated portion 12, the lower auxiliary roller 118 may function to limit the deformation of the lower belt 116 in the inward direction between the plurality of rollers provided to the lower roller 117, so that the pressurizing force of the lower belt 116 may be transmitted to the non-coated portion 12.

In FIGS. 3 to 5, the upper auxiliary roller 114 is illustrated as being disposed between all the rollers provided to the upper roller 113, but the upper auxiliary roller 114 may also be disposed only between some of the rollers provided to the upper roller 113. The lower auxiliary roller 118 may also be disposed only between some of the rollers provided to the lower roller 117.

The rolling roller portion 120 may pressurize a coated portion 11 to roll the coated portion 11. The rolling roller portion 120 may include at least one pair of rollers to pressurize the coated portion 11 from an upper portion and a lower portion of the electrode 10. For example, the rolling roller portion 120 may include an upper rolling roller 121 and a lower rolling roller 122 that pressurize the coated portion 11 from the upper portion and the lower portion of the electrode 10. The rolling roller portion 120 may roll the electrode 10 over an entire width of the electrode 10. For example, axial lengths (corresponding to the width direction of the electrode) of the upper rolling roller 121 and the lower rolling roller 122 may be greater than a width of the electrode 10, respectively, so that the upper rolling roller 121 and the lower rolling roller 122 have widths that cover both the coated portion 11 and the non-coated portion 12, respectively. The rolling reduction of the rolling roller portion 120 may be determined by considering a thickness reduction amount of the active material (or a slurry) applied to the foil, a thickness of the coated portion 11 in the rolled state, and the like.

The rolling roller portion 120 may be disposed at a rear end of the elongating belt portion 110 in the movement direction (X-direction) of the electrode 10.

That is, the rolling roller portion 120 may roll the coated portion 11 in a state in which the non-coated portion 12 is elongated by the elongating belt portion 110. In the rolling process by the rolling roller portion 120, due to a difference in a thickness between the coated portion 11 and the non-coated portion 12, a difference in the rolling reduction by the rolling roller portion 120 between the coated portion 11 and the non-coated portion 12 may occur. That is, since the coated portion 11 has a relatively thicker thickness than the non-coated portion 12, the amount of elongation of the coated portion 11 may have a relatively greater value than that of the non-coated portion 12. According to an embodiment, since the coated portion 11 is elongated by the rolling roller portion 120 in a state in which the non-coated portion 12 is elongated by the elongating belt portion 110, the difference in the amount of elongation between the coated portion 11 and the non-coated portion 12 may be reduced. Accordingly, the fracture of the electrode 10 may be prevented or reduced in the process of performing a rolling operation by the rolling roller portion 120 and/or the subsequent process.

Since the rolling roller portion 120 pressurizes the coated portion 11 and the non-coated portion 12 together, not only may the coated portion 11 be elongated, but also the non-coated portion 12a in the elongated state may be straightened. Accordingly, the non-coated portion 12 of the electrode 10 having passed through the rolling roller portion 120 may be in a flat state without wrinkles.

Meanwhile, in the case of the embodiment illustrated in FIGS. 1 to 5, since the upper belt 112 and the lower belt 116 provided in the elongating belt portion 110 have a shape extending long in the movement direction (X-direction) of the electrode, the elongation process time may be lengthened, and an entire elongation amount of the non-coated portion 12 may be distributed to the long upper belt 112 and lower belt 116, and thus, it may also be possible to omit the heating process. In this case, since the material strength of the non-coated portion 12 may be prevented from being reduced, an occurrence of defects in the subsequent process (e.g., the welding process of the electrode tab) may be reduced. According to an embodiment, the fracture phenomenon of the electrode 10 may be reduced without reducing the strength of the electrode 10 in the elongation process of the non-coated portion 12. However, the present disclosure does not exclude a heating portion or a heating process, and may also include a heating portion 130 (see FIG. 10) as in the other embodiment illustrated in FIG. 10.

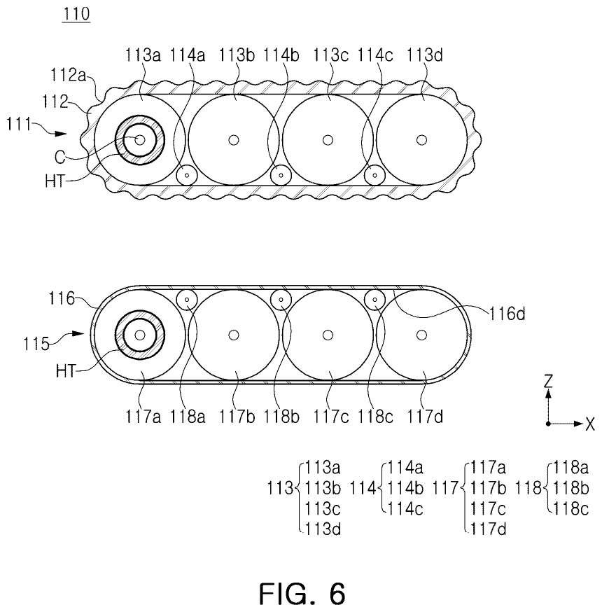

FIG. 6 is a cross-sectional view illustrating a modified example of the elongating belt portion 110 illustrated in FIG. 4.

As compared to the elongating belt portion 110 described in FIGS. 1 to 5, an elongating belt portion 110 illustrated in FIG. 6 differs from that of FIGS. 1 to 5 in that a heater is disposed on at least some rollers. The description of the elongating belt portion 110 described in FIGS. 1 to 5 may also be applied to the modified example of FIG. 6 except for the difference.

In an embodiment of FIG. 6, at least one of the plurality of rollers disposed in the upper roller 113 or the plurality of rollers disposed in the lower roller 117 may include a heater.

A heater disposed in at least one of the plurality of rollers disposed on the upper roller 113 may heat the upper belt 112. When a temperature of the upper belt 112 rises to a certain degree, the formability of the non-coated portion 12 pressurized by the upper belt 112 may be improved. Similarly, a heater disposed on at least one of the plurality of rollers disposed on the lower roller 117 may heat the lower belt 116. When the temperature of the lower belt 116 rises to a certain degree, the formability of the non-coated portion 12 pressurized by the lower belt 116 may be improved.

Although the embodiment of FIG. 6 illustrates a configuration in which the heaters are disposed in the first upper roller 113a of the upper roller 113 and in the first lower roller 117a of the lower roller 117, the number and/or positions of the rollers on which the heaters are installed may be variously changed.

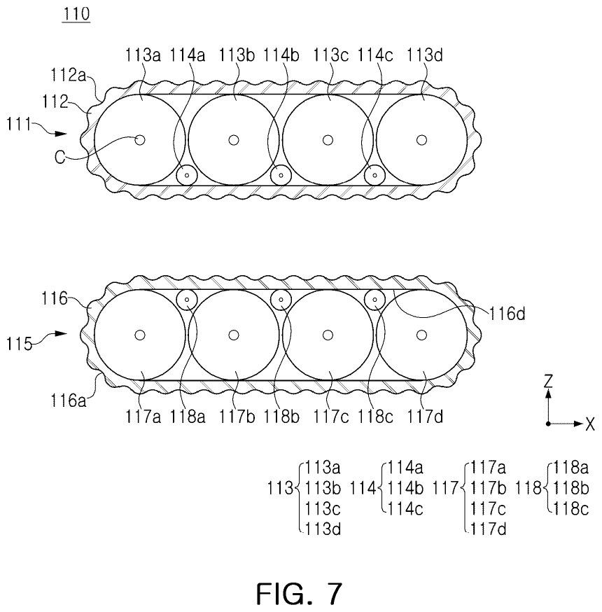

FIG. 7 is a cross-sectional view illustrating another modified example of the elongating belt portion 110 illustrated in FIG. 4.

As compared to the elongating belt portion 110 described in FIGS. 1 to 5, the elongating belt portion 110 illustrated in FIG. 7 differs from that of FIGS. 1 to 5 in that a pattern 112a is formed on both the upper belt 112 and the lower belt 116. The description of the elongating belt portion 110 described in FIGS. 1 to 5 may also be applied to the modified example of FIG. 7, except for the difference.

In an embodiment of FIG. 7, the upper belt 112 may include a pattern 112a having a protruding shape formed on an outer surface thereof, and the lower belt 116 may include a pattern 116a having a protruding shape formed on an outer surface thereof. When the patterns 112a and 116a are formed in the upper belt 112 and the lower belt 116, respectively, initial positions of the upper belt 112 and the lower belt 116 may be set so that the pattern 112a of the upper belt 112 and the pattern 116a of the lower belt 116 are interlocked with each other. Additionally, the upper belt 112 and the lower belt 116 may be driven in a synchronized state so that the upper belt 112 and the lower belt 116 are interlocked with each other during rotational movement.

FIG. 8A and FIG. 8B are cross-sectional views respectively illustrating a circumferential cross-section of the roller.

Referring to FIGS. 8A and 8B, at least some of the rollers provided to the upper roller 113 and the lower roller 117 may include a surface treatment portion 113x configured to increase the coefficient of friction when in contact with the inner surface 112d of the upper belt 112 or the inner surface 116d of the lower belt 116 as compared to the roller surface that is not surface treated or which is smooth.

The surface treatment portion 113x will be described by taking one of a plurality of rollers provided on the upper roller 113 of the upper elongating portion 111 as an example.

Referring to FIGS. 8A and 8B together with FIG. 4, the roller may include a body B having a cylindrical shape and a surface treatment portion 113x formed on an outer surface BS of the body B. When the outer surface BS of the body B has a smooth surface, the surface friction coefficient has a small value. If the outer surface BS of the roller has a smooth surface, when the outer surface BS of the roller and the inner surface 112d of the upper belt 112 come into contact with each other, slip may occur between the outer surface BS of the roller and the inner surface 112d of the upper belt 112, and accordingly, the rotation of the upper belt 112 may not be smooth.

The surface treatment portion 113x may be disposed on at least one of the plurality of rollers provided to each of the upper roller 113 and the lower roller 117. When slipping between the upper roller 113 and the upper belt 112 and/or between the lower roller 117 and the lower belt 116 may be prevented, the surface treatment portion 113x may be provided to only some of the plurality of rollers. For example, the surface treatment portion 113x may be provided to at least one roller among the upper rollers 113, but may not be provided to the lower roller 117. In this case, the surface treatment portion 113x of the roller may smoothly transmit driving force to the upper belt 112 to rotate the upper belt 112, and the non-coated portion 12 in contact with the upper belt 112 and the lower belt 116 in contact with the non-coated portion 12 may move together according to the rotation of the upper belt 112.

At least a portion of a roller transmitting the driving force to a belt, among the plurality of rollers disposed in the upper roller 113 and the lower roller 117, may include the surface treatment portion 113x. However, the surface treatment portion 113x may also be formed on a roller that does not transmit the driving force to the belt.

According to an embodiment, the surface treatment portion 113x may include an integral configuration formed on the outer surface BS of the body B so as to increase the coefficient of friction when in contact with the inner surface 112d of the upper belt 112 or the inner surface 116d of the lower belt 116. For example, the surface treatment portion 113x may include at least one of a concave-convex portion 113y formed by concave-convex processing to have a predetermined pattern 112a on surfaces of at least some rollers, and a surface coated portion 113z in which a coating material is coated on the surfaces of the at least some rollers.

Referring to FIG. 8A, the surface treatment portion 113x of the roller may include a concave-convex portion 113y. The concave-convex portion 113y may be formed to have a predetermined pattern 112a on a surface of the roller. For example, as illustrated in FIG. 8A, the concave-convex portion 113y may have a concave-convex shape having a constant pitch P and a constant height H. The concave-convex portion 113y having the constant pitch P and the constant height H may have a shape extending in an axial direction of the roller (corresponding to the width direction of the electrode). Since the concave-convex portion 113y forms a peak and a valley, when the concave-convex portion 113y comes into contact with the inner surface 112d of the upper belt 112 or the inner surface 116d of the lower belt 116, friction may increase, so that slipping between the roller and the upper belt 112 may be prevented. In FIG. 8A, the shape of the concave-convex portion 113y is illustrated as having a curved surface, but the shape of the concave-convex portion 113y may also include a shape including square corners or a shape including a long distance between the peak and the valley. For example, the concave-convex portion 113y may have an outer surface shape of a sprocket or an outer surface shape of a gear. Additionally, a groove for accommodating the concave-convex portion 113y may be formed on an inner surface of the belt in response to the shape of the concave-convex portion 113y.

The height H of the concave-convex portion 113y may be 5 mm or less, 4 mm or less, 3 mm or less, 2 mm or less, or 1 mm or less. The height H of the concave-convex portion 113y may have a value of 0.5 mm or more. The outer surface BS of the roller body B may have a circular cross-section, and the height H of the concave-convex portion 113y may be defined as a height protruding in a radial direction from the outer surface BS of the roller body B. The pitch P of the concave-convex portion 113y may be defined as a distance between peaks. In the present disclosure, the pitch P of the concave-convex portion 113y may be defined as an arc length in a circumferential direction from a vertex of the concave-convex portion 113y. The pitch P of the concave-convex portion 113y may have a value of 20 mm or less, 15 mm or less, 10 mm or less, 5 mm or less, or 3 mm or less. The pitch P of the concave-convex portion 113y may have a value of 0.5 mm or more, or 1 mm or more. However, the height H and the pitch P of the concave-convex portion 113y are not limited to the aforementioned values, and various changes thereof are possible as long as slipping may be prevented.

As described above, the concave-convex portion 113y of the present disclosure is not limited to a curved surface, and the shape and structure of the concave-convex portion 113y may be variously changed. Additionally, the concave-convex portion 113y may be formed by a process of forming a grid-like micro-concave-convex shape on the surface of the roller or a process of increasing surface roughness.

Referring to FIG. 8B, the surface treatment portion 113x may include a concave-convex portion 113y and a surface coated portion 113z. The surface coated portion 113z may be formed by coating a coating material on the surface of the roller. The surface coated portion 113z may be formed of various coating materials as long as the materials may increase the coefficient of friction as compared to a roller surface that is not surface treated or is smooth. As an example, the coating material may include materials such as silicone and rubber. The surface coated portion 113z may be formed on the surface of the concave-convex portion 113y as shown in FIG. 8B, but the present disclosure is not limited thereto. For example, the surface coated portion 113z may also be formed directly on the outer surface BS of the roller body B. A thickness t of the surface coated portion 113z may be set according to the material of the surface coated portion 113z or a method of forming the surface coated portion 113z on the roller.

As described in FIGS. 8A and 8B, when the surface treatment portion 113x is formed on the surface of the roller to increase the coefficient of friction, the slip phenomenon between the upper belt 112 and the upper roller 113 may be prevented or reduced, and accordingly, the driving force of the upper roller 113 may be smoothly transmitted to the upper belt 112, thereby preventing or reducing the slip phenomenon between the upper belt 112 and the non-coated portion 12. Accordingly, damage to the non-coated portion 12 due to the slipping phenomenon during the elongation process of the non-coated portion 12 may be prevented.

The description of the surface treatment unit 113x with reference to FIGS. 8A and 8B may be applied to at least some rollers, among the plurality of rollers provided to the upper roller 113 as well as at least some rollers, among the plurality of rollers provided to the lower roller 117. In this case, the surface treatment unit 113x may prevent or reduce the slipping phenomenon between the lower belt 116 and the lower roller 117, and accordingly, the driving force of the lower roller 117 may be smoothly transmitted to the lower belt 116, thereby preventing or reducing the slipping phenomenon between the lower belt 116 and the non-coated portion 12. Accordingly, damage to the non-coated portion 12 due to the slipping phenomenon during the elongation process of the non-coated portion 12 may be prevented.

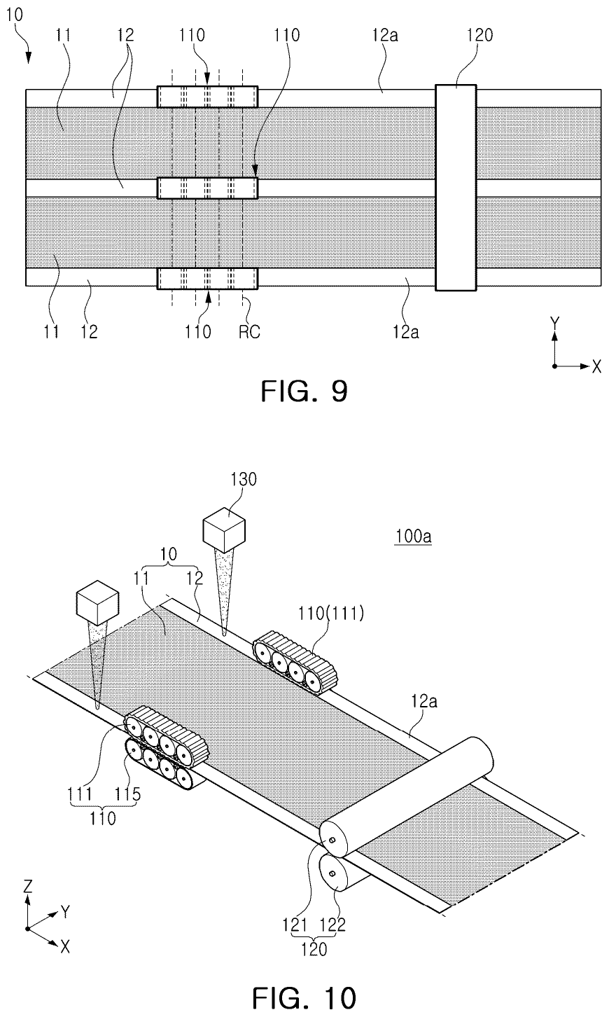

FIG. 9 is a plan view illustrating a manufacturing apparatus 100 for an electrode according to a modified embodiment.

Referring to FIG. 9, the electrode 10 may include a plurality of coated portions 11 and a plurality of non-coated portions 12. When the plurality of non-coated portions 12 are disposed in the electrode 10, the elongating belt portion 110 may be installed in each non-coated portion 12. A plurality of rollers disposed in each non-coated portion 12 may face each other, and the rollers facing each other may share a rotation axis RC. In this case, a driving mechanism for the rollers for elongating the plurality of non-coated portions 12 may be easily installed. For example, the plurality of rollers may be driven simultaneously through a single driving mechanism such as a single motor.

When the plurality of coated portions 11 are disposed in the electrode 10, the rolling roller portion 120 may roll the electrode 10 over an entire width of the electrode 10. For example, the rolling roller portion 120 may have a width that covers both the plurality of coated portions 11 and the plurality of non-coated portions 12, so that an axial length of the rolling roller portion 120 may have a value greater than the width of the electrode 10.

FIG. 10 is a perspective view schematically illustrating a manufacturing apparatus 100a of an electrode according to another embodiment.

The manufacturing apparatus 100a of an electrode illustrated in FIG. 10 may additionally include a heating portion 130 disposed in a front end of the elongating belt portion 110 in the movement direction (X-direction) of the electrode 10 to heat the non-coated portion 12. The heating portion 130 is not an essential component in the manufacturing apparatus 100 for an electrode of the present disclosure, but may be additionally included in the manufacturing apparatus 100 for an electrode.

The heating portion 130 may perform heat treatment to reduce the yield strength of the electrode material (e.g., foil) and may thus improve the formability of the non-coated portion 12. That is, the heating portion 130 may function to induce easy deformation in the elongation process of the non-coated portion 12. For example, the heating portion 130 may include a device for irradiating a laser. The heating portion 130 may irradiate a laser to the non-coated portion 12 to increase a temperature of the non-coated portion 12. The intensity and area of the laser irradiated to the non-coated portion 12 may be determined according to the electrode 10 manufacturing specifications. However, the heating portion 130 is not limited to the configuration described above. For example, the heating portion 130 may use an induction heating device, and various other modifications thereof are possible.

FIG. 11 is a flow chart illustrating a manufacturing method (S100) of an electrode according to an embodiment.

Referring to FIG. 11 together with FIGS. 1 to 10, manufacturing method (S100) of an electrode according to an embodiment may include a process (S110) of preparing a coating electrode 10 including a coated portion 11 on which an active material is applied to a foil and a non-coated portion 12 on which the active material is not applied, a process (S130) of elongating the non-coated portion 12 by pressurizing the non-coated portion 12, and a process (S140) of rolling the coated portion 11 by pressurizing the coated portion 11. In the process (S130) of elongating the non-coated portion 12, pressure may be applied to the non-coated portion 12 using the upper elongating portion 111 including the upper belt 112 pressurizing the non-coated portion 12 in an upper portion of the non-coated portion 12 and the lower elongating portion 115 including the lower belt 116 pressurizing the non-coated portion 12 in a lower portion of the non-coated portion 12.

The process (S110) of preparing the coating electrode is a process of preparing an electrode substrate in a dried state after a slurry is applied to the foil (or a current collector). In the present disclosure, the coating electrode may be defined as an electrode substrate before the process (S130) of elongating the non-coated portion 12 and the process (S140) of rolling the coated portion 11 are performed. The electrode 10 manufactured by the present disclosure may be defined as an electrode 10 in a rolled state through the process (S140) of rolling the coated portion 11. The process (S110) of preparing the coating electrode 10 is a process of preparing an electrode substrate including the coated portion 11 on which the active material is applied to the foil and the non-coated portion 12 in which the active material is not applied.

The process (S130) of elongating the non-coated portion 12 may be performed through the elongating belt portion 110. Accordingly, the description of the elongating belt portion 110 may also be applied to the process (S130) of elongating the non-coated portion 12.

In the process (S130) of elongating the non-coated portion 12, the non-coated portion 12 may be elongated by pressurizing the non-coated portion 12 through the upper belt 112 provided in the upper elongating portion 111 and the lower belt 116 provided in the lower elongating portion 115. The upper belt 112 may pressurize the non-coated portion 12 in the upper portion of the non-coated portion 12, and the lower belt 116 may pressurize the non-coated portion 12 in the lower portion of the non-coated portion 12. That is, the non-coated portion 12 may be pressurized and modified between the upper belt 112 and the lower belt 116.

At least one of the upper belt 112 or the lower belt 116 may include a pattern 112a having a concave-convex shape formed on an outer surface thereof. The process of elongating the non-coated portion 12 may form a concave-convex shape corresponding to the pattern 112a on the non-coated portion 12.

For example, a concave-convex pattern 112a may be formed on an outer surface of one of the upper belt 112 and the lower belt 116, and an outer surface of the other may have a flat shape.

The pattern 112a may include a concave portion 112c and a convex portion 112b. By the pattern 112a having the concave portion 112c and the convex portion 112b, the non-coated portion 12 may be elongated while being formed into a shape similar to the pattern 112a.

In an embodiment, the upper elongating portion 111 may further include an upper roller 113 disposed on an inner side of the upper belt 112 and provided with a plurality of rollers. That is, the upper elongating portion 111 according to an embodiment may include an upper belt 112 and an upper roller 113.

The upper roller 113 may include two or more rollers. For example, the upper roller 113 may include a first upper roller 113a, a second upper roller 113b, a third upper roller 113c, and a fourth upper roller 113d. When the number of rollers provided to the upper roller 113 is plural, the length LB1 of the upper belt 112 on the inner surface 112d of the upper belt 112 may have a value that is two or more times the height HB1 of the upper belt 112. Accordingly, since the time of the process of performing the elongation of the non-coated portion 12 increases, the amount of deformation applied to the non-coated portion 12 may be distributed by the upper belt 112 having a long length.

In an embodiment, the lower elongating portion 115 may further include a lower roller 117 disposed on the inner side of the lower belt 116 and provided with a plurality of rollers. That is, the lower elongating portion 115 according to an embodiment may include a lower belt 116 and a lower roller 117.

The lower roller 117 may include two or more rollers. For example, the lower roller 117 may include a first lower roller 117a, a second lower roller 117b, a third lower roller 117c, and a fourth lower roller 117d. In the case in which the number of rollers provided to the lower roller 117 is plural, the length LB2 of the lower belt 116 on the inner surface 116d of the lower belt 116 may have a value that is two or more times the height HB2 of the lower belt 116. Accordingly, since the time of the process of performing the elongation of the non-coated portion 12 increases, the amount of deformation applied to the non-coated portion 12 may be distributed by the lower belt 116 having a long length.

In this manner, according to an embodiment, since the time of the process of performing the elongation of the non-coated portion 12 increases, the fracture phenomenon occurring in the non-coated portion 12 or a boundary area between the non-coated portion 12 and the coated portion 11 during the elongation of the non-coated portion 12 may be reduced.

In the process (S130) of elongating the non-coated portion 12, the upper roller 113 may support the inner surface 112d of the upper belt 112, and the lower roller 117 may support the inner surface 116d of the lower belt 116.

The upper roller 113 may support the inner surface 112d of the upper belt 112 on the inner side of the upper belt 112. The upper roller 113 may function to limit the deformation of the upper belt 112 in the inward direction when the upper belt 112 pressurizes the non-coated portion 12, so that the pressurizing force of the upper belt 112 may be transmitted to the non-coated portion 12. The lower roller 117 may support the inner surface 116d of the lower belt 116 on the inner side of the lower belt 116. The lower roller 117 may function to limit the deformation of the lower belt 116 in the inward direction when the lower belt 116 pressurizes the non-coated portion 12, so that the pressurizing force of the lower belt 116 may be transmitted to the non-coated portion 12.

In an embodiment, the upper elongating portion 111 may further include an upper auxiliary roller 114 disposed between at least some rollers, among the plurality of the rollers provided to the upper roller 113. That is, the upper elongating portion 111 according to an embodiment may include an upper belt 112, an upper roller 113, and an upper auxiliary roller 114.

For example, the upper auxiliary roller 114 may include a first upper auxiliary roller 114a disposed between the first upper roller 113a and the second upper roller 113b, a second upper auxiliary roller 114b disposed between the second upper roller 113b and the third upper roller 113c, and a third upper auxiliary roller 114c disposed between the third upper roller 113c and the fourth upper roller 113d.

The lower elongating portion 115 may further include a lower auxiliary roller 118 disposed between at least some rollers, among the plurality of rollers provided to the lower roller 113. That is, the lower elongating portion 115 according to an embodiment may include a lower belt 116, a lower roller 117, and a lower auxiliary roller 118.

For example, the lower auxiliary roller 118 may include a first lower auxiliary roller 118a disposed between the first lower roller 117a and the second lower roller 117b, a second lower auxiliary roller 118b disposed between the second lower roller 117b and the third lower roller 117c, and a third lower auxiliary roller 118c disposed between the third lower roller 117c and the fourth lower roller 117d.

In the process of elongating the non-coated portion 12, the upper auxiliary roller 114 may support the inner surface 112d of the upper belt 112 together with the upper roller 113, and the lower auxiliary roller 118 may support the inner surface 116d of the lower belt 116 together with the lower roller 117.

When the upper belt 112 pressurizes the non-coated portion 12, the upper auxiliary roller 114 may function to limit the deformation of the upper belt 112 in the inward direction between the plurality of rollers provided to the upper roller 113, so that the pressurizing force of the upper belt 112 may be transmitted to the non-coated portion 12. Similarly, when the lower belt 116 pressurizes the non-coated portion 12, the lower auxiliary roller 118 may function to limit the deformation of the lower belt 116 in the inward direction between the plurality of rollers provided in the lower roller 117 so that the pressurizing force of the lower belt 116 may be transmitted to the non-coated portion 12.

The process (S140) of rolling the coated portion 11 may be performed through the rolling roller portion 120. Accordingly, the description of the rolling roller portion 120 may also be applied to the process (S140) of rolling the coated portion 11. The process (S140) of rolling the coated portion 11 may be performed subsequent to the process (S130) of elongating the non-coated portion 12. In the process (S140) of rolling the coated portion 11, the rolling roller portion 120 may pressurize the coated portion 11 and the non-coated portion 12 together, so that not only may the coated portion 11 be elongated, but also the non-coated portion 12a in the elongated state may be straightened. Accordingly, the non-coated portion 12 of the electrode 10 having passed through the rolling roller portion 120 may form a flat state without wrinkles.

Additionally, the electrode manufacturing method (S100) according to an embodiment may additionally include a heating process (S120) of heating the non-coated portion 12. The heating process (S120) may be performed before the process (S130) of elongating the non-coated portion 12. In the present disclosure, the heating process (S120) is not an essential component and may be performed additionally. The heating process (S120) may improve the formability of the non-coated portion 12 by performing a heat treatment to reduce the yield strength of the electrode material. The heating process (S120) may be performed by the heating portion 130, and the description of the heating portion 130 may also be applied to the heating process (S120).

The contents described above are merely examples of applying the principles of the present disclosure, and other components may be further included within a scope that does not depart from the scope of the present disclosure. Additionally, some components may be deleted from the above-described embodiments, and each embodiment may be combined with each other.

What is claimed is:

1. A manufacturing apparatus for an electrode including a coated portion on which an active material is applied to a foil and a non-coated portion on which an active material is not applied to the foil, the manufacturing apparatus comprising:
an elongating belt portion configured to elongate the non-coated portion by pressurizing the non-coated portion; and
a rolling roller portion configured to roll the coated portion by pressurizing the coated portion,
wherein the elongating belt portion includes an upper elongating portion including an upper belt pressurizing the non-coated portion in an upper portion of the non-coated portion, and a lower elongating portion including a lower belt pressurizing the non-coated portion in a lower portion of the non-coated portion.

2. The manufacturing apparatus for an electrode of claim 1, wherein on an inner surface of the upper belt, a length of the upper belt in a direction of movement of the electrode is greater than a height of the upper belt, and
on an inner surface of the lower belt, a length of the lower belt in the direction of movement of the electrode is greater than a height of the lower belt.

3. The manufacturing apparatus for an electrode of claim 2, wherein the length of the upper belt is two or more times the height of the upper belt, and
the length of the lower belt is two or more times the height of the lower belt.

4. The manufacturing apparatus for an electrode of claim 1, wherein at least one of the upper belt or the lower belt includes a pattern having a concave-convex shape formed on an outer surface.

5. The manufacturing apparatus for an electrode of claim 4, wherein the pattern includes a concave portion and a convex portion, and
the convex portion includes a curved shape.

6. The manufacturing apparatus for an electrode of claim 1, wherein the upper elongating portion further includes an upper roller including a plurality of rollers disposed on an inner side of the upper belt, and
the lower elongating portion further includes a lower roller including a plurality of rollers disposed on an inner side of the lower belt.

7. The manufacturing apparatus for an electrode of claim 6, wherein the upper roller is in contact with both upper and lower sides of an inner surface of the upper belt, respectively, and
the lower roller is in contact with both upper and lower sides of an inner surface of the lower belt, respectively.

8. The manufacturing apparatus for an electrode of claim 6, wherein at least one of the plurality of rollers disposed on the upper roller provides driving force to the upper belt, and
at least one of the plurality of rollers disposed on the lower roller provides driving force to the lower belt.

9. The manufacturing apparatus for an electrode of claim 6, wherein at least some rollers, among the plurality of rollers provided to the upper roller and the lower roller include a surface treatment portion configured to increase a coefficient of friction when in contact with an inner surface of an upper belt or an inner surface of the lower belt, as compared to a roller surface that is not surface-treated or which is smooth.

10. The manufacturing apparatus for an electrode of claim 9, wherein the surface treatment portion includes at least one of a concave-convex portion formed to have a predetermined pattern on a surface of the at least some rollers or formed by concave-convex processing, or a surface coated portion in which a coating material is coated on a surface of the at least some rollers.

11. The manufacturing apparatus for an electrode of claim 6, wherein the upper elongating portion further includes an upper auxiliary roller including at least one auxiliary roller disposed between the at least some rollers, among the plurality of rollers provided to the upper roller.

12. The manufacturing apparatus for an electrode of claim 11, wherein the upper auxiliary roller is in contact with an inner surface of the upper belt below a central axis of the upper roller.

13. The manufacturing apparatus for an electrode of claim 6, wherein the lower elongating portion further includes a lower auxiliary roller including at least one auxiliary roller disposed between at least some rollers, among the plurality of rollers provided to the lower roller.

14. The manufacturing apparatus for an electrode of claim 1, wherein the rolling roller portion is disposed at a rear end of the elongating belt portion in a direction of movement of the electrode.

15. The manufacturing apparatus for an electrode of claim 1, further comprising:
a heating portion disposed in a front end of the elongating belt portion in a direction of movement of the electrode to heat the non-coated portion.

16. A manufacturing method of an electrode, the method comprising:
a process of preparing a coating electrode including a coated portion in which an active material is applied to a foil and a non-coated portion in which an active material is not applied to the foil;
a process of elongating the non-coated portion by pressurizing the non-coated portion; and
a process of rolling the coated portion by pressurizing the coated portion,
wherein in the process of elongating the non-coated portion, pressure is applied to the non-coated portion using an upper elongating portion including an upper belt pressurizing the non-coated portion in an upper portion of the non-coated portion, and a lower elongating portion including a lower belt pressurizing the non-coated portion in a lower portion of the non-coated portion.

17. The manufacturing method of an electrode of claim 16, wherein at least one of the upper belt or the lower belt includes a pattern having a concave-convex shape formed on an outer surface the at least one of the upper belt or the lower belt, and
in the process of elongating the non-coated portion, a concave-convex shape corresponding to the pattern is formed in the non-coated portion.

18. The manufacturing method of an electrode of claim 16, wherein the upper elongating portion further includes an upper roller disposed on an inner side of the upper belt and provided with a plurality of rollers,
the lower elongating portion further includes a lower roller disposed on an inner side of the lower belt and provided with a plurality of rollers, and
in the process of elongating the non-coated portion, the upper roller supports an inner surface of the upper belt and the lower roller supports an inner surface of the lower belt.

19. The manufacturing method of an electrode of claim 18, wherein the upper elongating portion further includes an upper auxiliary roller disposed between at least some rollers, among the plurality of rollers provided to the upper roller,
the lower elongating portion further includes a lower auxiliary roller disposed between at least some rollers, among the plurality of rollers provided to the lower roller, and
in the process of elongating the non-coated portion, the upper auxiliary roller supports the inner surface of the upper belt together with the upper roller, and the lower auxiliary roller supports the inner surface of the lower belt together with the lower roller.

20. The manufacturing method of an electrode of claim 16, further comprising:
a heating process of heating the non-coated portion,
wherein the heating process is performed before the process of elongating the non-coated portion, and
the process of rolling the coated portion is performed subsequent to the process of elongating the non-coated portion.
